(19) United States
(12) Patent Application Publication
(10) Pub. No.: US 2018/0220807 A1
(43) Pub. Date: Aug. 9, 2018

(54) FLAME RETARDANT COVER

(71) Applicant: FOSBROOKE, INC., PHOENIX, AZ (US)

(72) Inventors: DANNY HONIG, NEW YORK, NY (US); JOHN THOMAS MARINO, PHOENIX, AZ (US); TYLER MARINO, PHOENIX, AZ (US); CHRISTOPHER ROBERT LEE, PHOENIX, AZ (US)

(21) Appl. No.: 15/891,887

(22) Filed: Feb. 8, 2018

Related U.S. Application Data
(60) Provisional application No. 62/456,743, filed on Feb. 9, 2017.

(51) Int. Cl. A47C 31/00; A47C 31/10; D02G 3/44; D06M 11/71; D04H 1/4218; D04H 1/4258; C01B 25/28

(52) U.S. Cl. CPC A47C 31/001; A47C 31/105; D02G 3/443; D06M 11/71; D10B 2505/08; D04H 1/4258; C01B 25/28; D06M 2200/30; D10B 2503/06; D04H 1/4218

(57) ABSTRACT

Flame retardant covers for mattress and flame retardant mattresses are provided. At least a portion of the fibers, yarns or the fabric of the covers is treated with a blend comprising a flame retardant compound such as ammonium phosphate. The covers do not further require any flame barrier element such as fiberglass or silica-loaded rayon. The mattresses provided herein fully comply with the federal mattress flammability standards of 16 C.F.R. 1632 and 1633.

### CROSS-REFERENCE TO RELATED APPLICATION

This application claims the benefit of U.S. Patent Provisional Application No. 62/456,743, filed on Feb. 9, 2017, which is incorporated herein by reference.

### FIELD OF THE INVENTION

The present invention relates, generally, to open flame resistant mattresses, mattress foundations, mattress pads, mattress toppers, pillows, cushions, upholstered furniture articles and other articles filled with combustible resilient cushioning materials, as well as covers enclosing the same.

### DESCRIPTION OF THE RELATED ART

The U.S. National Fire Protection Association (NFPA) estimates that during 2005-2009, a mattress or bedding was the item first ignited in an average of 10,260 reported home structure fires per year. These fires caused an estimated annual average of 371 civilian deaths, 1,340 civilian injuries, and $382 million in direct property damage. These fires accounted for 3% of all home structure fires, 14% of deaths, 10% of injuries and 5% of property damage.

Such statistics associated with these residential “mattress” fires has led to regulatory efforts from the U.S. federal government to reduce flammability of mattresses, upholstered furniture and bedclothes sed in homes and other occupancies such as hospitals. In particular, residential mattresses are subject to two federal flammability standards administered by the Consumer Product Safety Commission (CPSC). These standards are codified in the code of federal regulations at 16 C.F.R. Parts 1632 and 1633, which are commonly called Parts 1632 and 1633.

The largest amount of fuel in most mattresses is the filling material inside a mattress which provides the consumer with comfort and support. The filling material is typically made of natural or synthetic fibers, latex foam and polyurethane foam, or various combinations of those different materials, all of which are highly combustible. Therefore, to meet federal standards for residential mattresses, manufacturers protect the combustible upholstery materials from being ignited.

In the case of Part 1632 (issued in the 1970's), manufacturers enclose the interior upholstery materials with materials that do not allow smoldering cigarettes to burn through the finished mattress surface to the interior materials. Most U.S. mattress manufacturers meet the standard by using an outer fabric made from various conventional fibers (e.g. polyester, polyolefin, wool, silk) that will resist ignition from a smoldering cigarette.

To meet the more demanding requirements of Part 1633 (implemented in 2007 to address fires ignited by open flame heat sources e.g. lighters, matches and candles), the mattress industry urged CPSC to adopt performance criteria that would not require manufacturers to use fire-retardant foam. As a result, manufacturers meet the performance requirements using fabric or fiber barriers to protect the interior foam and other material from igniting. The barriers are designed to block either heat, oxygen or both from reaching the upholstery material that the barriers encase. These barriers, which are often referred to as “sock, “mattress sock,” “fire sock” or “fire barrier sock” in the industry, may be in the form of woven or knit fabrics, or non-woven fiber pads. They may either be sewn into the mattress between the ticking cover and the interior upholstery material, or be part of the outer fabric cover, i.e. being integrated to form a matrix. The barriers are made from a variety of natural and synthetic fibers that have been tested extensively and used safely for decades in a variety of fire protection and other applications. Essentially, these fibers in the barriers function to protect a mattress by forming a char when exposed to an ignition source.

One such fiber and which is possibly the most commonly used fiber in the industry is fiberglass, which is term for a man-made fiber-reinforced plastic or a continuous glass filament that may also be called fibrous glass or glass wool. However, fiberglass poses serious problems to human health. For example, larger fibers have been found to cause skin, eye and upper respiratory tract irritation. Soreness in the nose and throat can result when fiberglass or its dust is inhaled. Asthma and bronchitis can be aggravated by exposure to fiberglass. Swallowing fiberglass can cause stomach irritation. On a graver note, fiberglass has also been identified as a carcinogen.

Another inherently flame retardant fiber that is used in mattress socks is silica-treated or silica-loaded rayon, which is also commonly referred to as “inherent rayon”. Rayon is produced by the contact and steeping of sulfite wood-pulp sheets (in a caustic solution (i.e. sodium hydroxide) that dissolves the alpha cellulose. In other words, rayon is a textile fiber or fabric made from regenerated cellulose. The alkali cellulose sheets are then reduced to crumbs and aged. The crumbs are put in contact with carbon disulfide (CS₂) to produce the xanthate. The major emission problem is CS₂, and significant safety data coming from the viscose rayon industry reveals both CS₂ as well as small amounts of hydrogen sulfide (H₂S) being present in the emission gas. At high levels, CS₂ may be life-threatening because it affects the nervous system. Inhalation of finely divided crystalline silica dust can lead to silicosis, bronchitis or cancer, as the dust becomes lodged in the lungs and continuously irritates the tissue, reducing lung capacities.

U.S. Pat. No. 7,473,659 discloses a fire barrier fabric comprising a multilayer fabric having at least two layers, including an outside layer and a fire barrier layer, where the fiber barrier layer provides flame retardant and/or flame resistant properties to the entire fabric without requiring fabric coatings or treatments to provide any contribution to flame retardance or resistance.

U.S. Pat. No. 7,484,256 discloses a retrofit cover for fully or partially enclosing a mattress, where the cover is formed of a unitary, integrally formed fabric having a fire barrier element.

U.S. Patent Application Publication No. 2006/0160451 describes use of a flame resistant knit tube (preferably 100% fiberglass), made with either a seamless or seamed circular knit or a seamed or tubular warp knit fabric, to protect a mattress, foundation, upholstery, pillow, etc.

U.S. Pat. Nos. 5,540,980; 6,146,759; and 6,410,140 each describe a fire resistant fabric formed from a corespun yarn comprising a high-temperature resistant, continuous filament fiberglass core and a low-temperature resistant staple fiber sheath surrounding the core.

U.S. Pat. No. 4,504,991 describes a mattress that includes a composite made of a layer of a fire retardant material capable of providing a heat barrier bonded to a layer of high tensile strength material, e.g. fiberglass fabric.

Each of the patent documents listed above is incorporated herein by reference in its entirety.

In view of the present state of the art, it would be highly beneficial to provide mattresses, other upholstered articles and covers thereof that are safe not only in terms having exhibit excellent flame retardant properties, but also towards human health and the environment.

### SUMMARY OF THE INVENTION

The present invention is generally directed to flame retardant covers for mattresses and flame retardant mattresses, mattress foundations, mattress pads, mattress toppers, pillows, cushion, upholstered furniture articles, and other articles filled with cushioning material, in particular combustible materials.

The present invention provides a flame retardant cover, comprising: a fabric comprising a network of yarns comprising a plurality of interlocked fibers; wherein at least a portion of the fibers, yarns or fabric is treated with a blend comprising a flame retardant compound; the fabric is substantially free of a flame barrier element; and the flame retardant cover is adapted for at least partially enclosing a core mass of stuffing material.

The present invention also provides a flame retardant mattress, comprising: a core mass of stuffing material; and a flame retardant cover adapted for at least partially enclosing the core mass of stuffing material, wherein the flame retardant cover comprises a fabric comprising a network of yarns comprising a plurality of interlocked fibers; at least a portion of the fibers, yarns or fabric is treated with a blend comprising a flame retardant compound; and the fabric is substantially free of a flame barrier element.

In order to meet the federal mattress flammability standards of 16 C.F.R. 1632 and 1633, U.S. manufacturers protect the highly combustible upholstery material with a fabric cover commonly known as the “sock.” These socks typically include a flame barrier element, most commonly fiberglass and silica-loaded rayon, that prevents fire from spreading. Fiberglass and silica, however, are known allergens and irritants, and prolonged exposure to the substance can also put people at risk of cancer, especially lung cancer.

The present invention provides a solution to the above-identified technical problem by reducing the amount or eliminating the use of fiberglass in mattresses. Instead, mattress socks of the present invention are treated with a blend comprising a flame retardant compound, preferably a flame retardant compound that is considerably safe towards human health such as ammonium phosphate. The socks are treated, preferably, by impregnating non-flame retardant yarns with the blend.

### BRIEF DESCRIPTION OF THE DRAWINGS

FIG. 1 is a depiction showing the surface (Surface 1) of a mattress having nine lit cigarettes placed on a section covered with a bed sheet. and another nine lit cigarettes placed an uncovered section.

FIG. 2 is a depiction showing the surface (Surface 2) of a mattress having nine lit cigarettes placed on a section covered with a bed sheet. and another nine lit cigarettes placed an uncovered section.

FIG. 3 is a graph showing rate of heat release against time in a Part 1633 mattress test.

FIG. 4 is a graph showing total heat release against time in a Part 1633 mattress test.

FIG. 5 is a graph showing rate of heat release against time in another Part 1633 mattress test.

FIG. 6 is a graph showing total heat release against time in another Part 1633 mattress test.

### DETAILED DESCRIPTION OF THE INVENTION

The present inventors have surprisingly discovered certain fabric covers that are intended as flame barriers, but are made with a reduced amount or no amount of flame barrier elements, are fully capable of rendering the encased mattress (or any other combustible resilient cushioning materials) flame retardant.

The covers of the present invention may be adapted for at least partially enclosing a core mass of stuffing material. In the context of the present invention, the term “adapted for” means embracing the capability, or is suitable or fit for. It is not required that the covers of the present invention to possess a structure or a structural feature that is more than just capable of performing a function, but is actually made to perform the function. The term “at least partially” in accordance with the present invention means the covers rest on at least a surface of the core mass of stuffing material. In some embodiments, at least about 50%, preferably at least about 60%, more preferably at least about 70%, even more preferably at least about 80%, even more preferably at least about 90% of the surface area of the core mass is covered. In some embodiments, the entire surface area of the core mass is covered. The term “core” or “core mass” refers to a main support system that may be present in a mattress, and can comprise stuffing material. The term “stuffing material” refers to a material, usually soft, that is used as a comfortable support for sleeping, lying, sitting or leaning on, and includes but is not limited to materials such as bird feathers, rice, beans, paper, molded pulp, bubble wrap, sponge and foam materials. Examples of common foam materials are polyurethane, latex, soy-based materials, castor-based materials, fibrous materials, convoluted foam, reticulated foam, spring coils, pocket spring coils, innerspring, extruded polymer, cotton, wool, horse hair, bamboo husk, coir fiber, kapok, buckwheat husk, etc. In one embodiment, a mattress of the present invention includes two layers of polyurethane foam wherein the top layer is composed of a fast recovery, open-cell visco-elastic foam with gel beads and graphite additives. The bottom layer is composed of a high-density polyurethane foam. The term “mattress” refers to a ticking filled with a resilient material used alone or in combination with other products intended or promoted for sleeping upon. Examples of mattresses includes, but are not limited to, adult mattresses, youth mattresses, crib mattresses including portable crib mattresses, bunk bed mattresses, futons, water beds and air mattresses which contain upholstery material between the ticking and the mattress core, and any detachable mattresses used in any item of upholstered furniture such as convertible sofa bed mattresses, corner group mattresses, day bed mattresses, roll-a-way bed mattresses, high risers, and trundle bed mattresses.

While the flame retardant covers of the invention may be used for mattresses, the covers may adapted for use in other applications, for example, any application wherein it is useful to provide a flame retardant effect. For example, the flame retardant covers may be adapted for use with any core of stuffing materials, including but not limited to any cushions or pillows, for example, for furniture such as chairs, sofas, ottomans, and other furniture or furniture-related items; and for automotives such as seat cushions, head rests, arm rests and other automotive-related items. In this application, the term “mattress” may be substituted with any other core of stuffing material (including but not limited to any of the cores of stuffing materials listed or described above).

The term “mattress pad” refers to a thin, flat mat or cushion, and/or ticking filled with resilient material for use on top of a mattress. Mattress pads includes, but are not limited to, absorbent mattress pads, flat decubitus pads, and convoluted foam pads which are totally enclosed in ticking. The term “ticking” refers to the outermost layer of fabric or related material that encloses the core and upholstery materials of a mattress or mattress pad. A mattress ticking may consist of several layers of fabric or related materials quilted together.

The term “filling material” refers to material, either loose or attached, between the mattress or mattress pad ticking and the core of a mattress, if a core is present.

The term “tape edge” or “edge” refers to the seam or border edge of a mattress or mattress pad.

The term “quilted” means stitched with thread or by fusion through the ticking and one or more layers of upholstery material.

The term “tufted” means buttoned or laced through the ticking and upholstery material and/or core, or having the ticking and upholstery material and/or core drawn together at intervals by any other method which produces a series of depressions on the surface.

The term “mattress foundation” refers to a surface such as foam, box springs or other, upon which a mattress is placed to lend it support for use in sleeping upon,

The term “flame retardant” refers to materials that does not ignite readily or propagate flames when exposed to fire. In some embodiments, an article is considered to be “flame retardant” if it meets the requirements set forth in both 16 C.F.R. Parts 1632 (Standard for the Flammability of Mattresses and Mattress Pads) and/or 1633 (Standard for the Flammability (Open Flame of Mattress Sets), which are incorporated herein by reference in their entireties.

The term “flame barrier element” refers to a material that has inherent char-forming, flame retardant properties. In some embodiments, the flame barrier element is a material that provides a reduced potential for igniting or propagating flames due to its physical structure and/or ability to form char. The term “flame barrier element” includes materials that have flame retardant properties even in the absence of a coating or application of a flame retardant compound. In some embodiments, a flame barrier element refers to a plurality of fibers. The term “char” as used herein is defined as a residue formed from a material that has been exposed to heat and/or flame, and which has been reduced or possesses no flammability, or ability to burn or ignite. The char may be formed from materials that have been incompletely burned and extinguished, or from materials that do not react chemically under conditions found in a fire, and so, are not flammable. The char may also possess mechanical strength and integrity and so can act as a physical barrier to prevent flames from contacting highly combustible interiors of mattresses and mattress foundations) and to prevent oxygen from getting to the fuel source. In some embodiments, the char does not melt, drip or shrink away from the ignition source, or display significant after-flame, or support these reactions at a level sufficient to cause ignition of adjacent materials.

Examples of flame barrier elements include but are not limited to aramids, para-aramids (poly(p-phenylene terephthalamide), meta-aramids (poly(m-phenylene isophthalamide), fiberglass, melamines, poly-benzimidazoles (PBI), oxidized polyacrylonites (PAN), novoloids, polyetherimides (PEI), silica fibers, pre-oxidized fibers, carbon fibers, modacrylics, FR (fire- or flame-resisting, -resistant, -retarding or -retardant) rayon, FR viscose, FR wool and FR polyesters. An example of an aramid is NOMEX®. Examples of para-aramid include but are not limited to KEVLAR® (Dupont Corporation) and TWARON® (Teijin Twaron BV). Examples of meta-aramids include but are not limited to NOMEX® (Dupont Corporation) and Conex® (Teijin Twaron BV). An example of melamines is BASOFIL® (BASF/Mckinnon-Land-Moran, LLC). An example of PBI's is Celazole®. An example of a novoloid is KYNOL® (American Kynol, Inc). An example of PEI's is ULTEM®. An example of silica fiber is OMNISIL®. Examples of modacrylics include but are not limited to KANECERON® and PROTEX® (Kaneka), SEF (Solutia) and LUFNEN® (Kanebo Goshen). Examples of FR viscose include but are not limited to VISIL® (Sateri Oy) and LENZING FR® (Lenzing AG, Fibers Division). An example of FR rayon is silica-treated or silica-loaded rayon. An example of FR polyesters is Trevira CS. The flame barrier elements may comprise a plurality of the above-listed fibers. It should be noted that these fibers are merely exemplary, and other flame retardant fibers that integrate their flame retardant performance during polymerization of the fibers, including fibers that are developed in the future may be used.

In some preferred examples, the flame barrier element comprises fiberglass. The term “fiberglass” refers to a reinforced plastic material composed of glass fibers embedded in a resin matrix or a textile fabric made from woven glass filaments. In other words, the glass fibers in the fiberglass may be randomly arranged, flattened a sheet or woven into a fabric. The term “fiberglass” also refers to a continuous filament of glass, where the glass fibers are extruded in a continuous form. The term “fiberglass” as used herein also encompasses fiberglass composites, including but not limited to glass fibers that are encapsulated, e.g. polymer-encapsulated glass fibers. One example of a common polymer-encapsulated glass fiber is polyamide- or PA-encapsulated glass fibers. All types of fiberglass typically contain silica or silicate, and varying amounts of oxides of calcium, magnesium, and sometimes boron. Examples of common fiberglass are polyester resin (not reinforced), polyester and chopped strand mat laminate 30% E-glass, polyester and woven rovings laminate 45% E-glass, polyester and satin weave cloth laminate 55% E-glass, polyester and continuous rovings laminate 70% E-glass, E-glass epoxy composite and S-glass epoxy composite. Examples of common types of glass fibers used in fiberglass are E-glass (alumino-borosilicate glass with less than 1% w/w alkali oxides), A-glass (alkali-lime glass with little or no boron oxide), E-CR-glass (Electrical/Chemical Resistance; alumino-lime with less than 1% w/w alkali oxides and with high acid resistance), C-glass (alkali-lime glass with high boron oxide content), D-glass (borosilicate glass and has low dielectric constant), R-glass (alumino silicate glass without magnesium oxide and calcium oxide and with high mechanical requirements as reinforcement) and S-glass (alumino silicate glass without calcium oxide but with high magnesium oxide content and with high tensile strength).

In some other preferred examples, the flame barrier element comprises silica-treated rayon, silica-treated viscose or silica-treated viscose rayon, which is the viscose rayon fiber that is bonded with silica or silicon dioxide during the fiber extrusion process.

Conventionally, the flame barrier element is incorporated by forming a matrix within a mattress flame retardant cover. For example, when the flame barrier of element comprises a plurality of fibers, the fibers may intertwine with other non-flame retardant fibers or yarns (e.g. cotton, polyester) to form a single tapestry of interwoven fibers. Alternatively, the flame barrier element may form a separate layer from the network of non-flame retardant yarns in the cover. In the case of fiberglass, the substance provides structural integrity so that chars of burned fibers will hold together, which prevents a breech that would allow oxygen to come in contact with fuel source to create a larger flame. As for silica-treated rayon, when exposed to an open flame, the polyester and the cellulosic portion of the viscose rayon will burn away, but the silica will remain to form a char barrier that will interrupt the flame enough to prevent mattress filling from catching fire during the timeframe mandated by 16 C.F.R. Part 1633.

The flame retardant covers of the present invention are substantially free of the flame barrier element described above. As used herein, being “substantially free of the flame barrier element” can refer to a cover which contains less than about 0.1% of inherently char-forming and flame retardant fibers per the total number of fibers contained in the cover, preferably about 0.001 to about 0.05%, more preferably about 0.001 to about 0.01%. In one embodiment, a flame retardant cover of the present invention contains less than about 0.1% of fiberglass per total number of fibers contained in the cover, preferably about 0.001% to about 0.05%, more preferably about 0.001% to about 0.01%. In some embodiments, the term “substantially free of the flame barrier element” refers to less than about 0.1% by weight of the total weight of the cover, preferably about 0.001% to about 0.05%, more preferably about 0.001% to about 0.01%. In one embodiment, a flame retardant cover of the present invention contains less than about 0.1% by weight of fiberglass, preferably about 0.001 to about 0.05%, more preferably about 0.001 to about 0.01%. “About” in reference to a numerical value refers to the range of values somewhat less or greater than the stated value, as understood by one of skill in the art. For example, the term “about” could mean a value ranging from plus or minus a percentage (e.g., ±1%, 2%, or 5%) of the stated value. Furthermore, since all numbers, values, and expressions referring to quantities used herein are subject to the various uncertainties of measurement encountered in the art, then unless otherwise indicated, all presented values may be understood as modified by the term “about.”

The covers of the present invention are treated with one or more flame retardant compounds. In some embodiments, the covers are treated with a flame retardant blend, such as a aqueous solution, containing at least a flame retardant compound. In some embodiments, the cover comprises fibers that are treated with the flame retardant blend, wherein the fibers are spun into yarns, which are then woven or knitted into the fabric cover. In an alternative and preferred embodiment, the cover comprises yarns that are treated with the flame retardant blend, wherein fibers are spun into yarns, which are then treated with the flame retardant blend prior to being woven or knitted into the fabric cover. In another embodiment, the fabric of the cover, which comprises a network of yarns comprising interlocked fibers, is treated with the blend. In the case of nonwoven fabrics which may also be used, the fibers are bonded together by chemical, mechanical, heat or solvent treatment, or a combination thereof. In some embodiments, two of more of the following are treated. For example, in some embodiments, the flame retardant compound treatment is applied to both fibers and yarns, and the cover comprises both treated fibers and treated yarns. In other some embodiments, the treatment is applied to fibers, yarns, and the fabric itself.

In the context of the present invention, when the fibers, yarns and/or the fabric of the flame retardant covers are “treated”, it means that, in a preferred embodiment, that the flame retardant blend does not merely form a physical layer on the surface of the fibers. Indeed, during the treatment process, the fibers are saturated in the flame retardant blend solution and when dried, these fibers become encapsulated with the flame retardant compound. Molecules of the flame retardant compound(s) adhere or cling to the fibers without forming any chemical bonds to the fibers. In other words, the fibers are impregnated, coated, filled up, absorbed or permeated with the flame retardant compound(s). In an alternative embodiment, treating the fibers, yarns and/or the fabric of the flame retardant covers leads to the effect of the flame retardant blend forming a physical coating on the surface of the fibers.

It should be noted that aside from being substantially free of a flame barrier element, present invention is by no means limited by the type of fiber or mixtures thereof used to make the flame retardant cover. Nor is it limited by the size of the fibers and yarns (including thickness and length). In some embodiments, the yarn comprises open-ended yarn. In some preferred embodiments, the yarn comprises ringspun yarn or any other yarn with a more structured orientation than open-ended yarn. It is preferred to use a yarn that has a higher breaking strength (ie, a stronger yarn) and good coefficient of variation and/or elongation. For example, a yarn, such as a ringspun yarn, may provide a lower/less coefficient variation and/or higher elongation, as there may be reduced potential of issues during production (ie, the use of such a yarn may allow for less build up of materials such as flame retardant compound(s) on machinery during production of the flame retardant cover).

In some embodiments, the cotton count is about 8/1 to about 40/1, alternatively about 10/1 to about 30/1, alternatively about 12/1 to about 32/1, alternatively about 15/1 to about 30/1, alternatively about 18/1 to about 28/1, alternatively about 20/1 to about 25/1, alternatively about 24/1. Accordingly, the fiber can be made from natural sources (e.g. animal hair or fur, insect cocoons as with silk worm cocoons), as well as semisynthetic methods that use naturally occurring polymers (e.g. plant-based cellulosic fibers such as cotton, non-FR rayon, non-FR viscose, modal, lyocell, acetate, hemp and bamboo), and synthetic methods that use synthetic, non-flame retardant fibers (e.g. nylon, polyester, polyethylene, polypropylene, polybutylene terephthalate, acrylic etc.). Preferably, the fabric is a blend of a thermoplastic fiber and a cellulosic fiber, especially preferably less than about 40% of a thermoplastic fiber and greater than about 50% of a cellulosic fiber. The cellulosic fibers promote the flame retardancy of the fabric cover by absorbing the flame retardant compound. The thermoplastic fibers, on the other hand, burn and melt to form a sticky substance when exposed to a flame, and this substance blocks the oxygen access to the fuel source (i.e. the combustible filling materials. Examples of thermoplastic fiber include, but are not limited to nylon, polyester, polyethylene, polypropylene, polybutylene terephthalate, and acrylic. This fabric blend preferably has a cellulosic fiber/thermoplastic fiber ratio of about 60:40, about 65:35, about 70:30, about 75:25, about 80:20, about 85:15, about 90:10, about 95:5, as well as any ratio between about 60:40 and about 99:1. In certain embodiments, the fabric blend has a cellulosic fiber/thermoplastic fiber ratio of about 100:1 to 1:100 including any ratio therebetween. In a particular embodiment, the flame barrier cover of the present invention comprises a single-knit fabric or a double-knit fabric. In some embodiments, the flame barrier cover is made by mechanically blending cotton fibers (about 75%) with recycled black polyester spun fiber (about 25%). In another embodiment, the flame barrier cover of the present invention comprises a blend of about 80% lyocell (or other cellulosic fiber) about 20% polyester. In yet another particular embodiment, the flame barrier cover is a 100% cellulosic fiber fabric, e.g. 100% cotton.

Neither is the present invention limited by the type of mattress, mattress pad, mattress foundation, upholstered furniture article or any other article having aa core of stuffing material that is at least partially encased by the flame barrier cover. Further, the present invention is not limited by the type of stuffing material used, which may be a foam (e.g. latex, polyurethane, fibrous foam), Representative and non-limiting examples of a flame retardant compound are aluminum hydroxide, magnesium hydroxide, phosphoric acid, dicyandiamide, cyanoguanidine, phosphonic acid huntite, hydromagnesite, mono ammonium phosphate, diammonium phosphate, ammonium polyphosphate, red phosphorus, antimony trioxide, zinc borate, zinc hydroxystannate, zinc stannate, a metal hydrate, a metal oxide, ammonium bromate, diguanidine hydrogen phosphate, aluminum trihydrate, calcium carbonate, gypsum, an organohalogen compound and an organophosphorus compound (.e.g. methylphosphonate acid, cyclic methylphosphonate), etc. Ammonium salts, such as ammonium phosphates, are preferred, especially (mono)ammonium phosphate. In some embodiments, the blend used to treat the flame retardant covers may comprise one flame retardant compound or a mixture of one or more flame retardant compounds. For example, in some embodiments, the blend comprises a mixture of flame retardant ammonium compounds and/or a mixture of inorganic salts. For example, in some embodiments, the blend comprises a mixture of ammonium phosphates such as mono ammonium phosphate, diammonium phosphate, and ammonium polyphosphate. Examples of suitable commercial flame retardant chemicals include Flovan CGN (Ciba), Pyrovatim PBS (Huntsman), Exolit AP-462 (Clariant), FR CROS 487 (Budenheim), FR CROS 489 (Budenheim), Antiblaze CU, Fyrol 51 (ICL Industrial Products) and Akro Fireguard (Akrofire).

The concentration of the flame retardant compound(s) in the blend ranges from about 10% to about 80% by weight per total weight of the blend solution (wt %), preferably from about 20 wt % to about 75 wt %, more preferably from about 30 wt % to about 70 wt %, even more preferably from about 40 wt % to about 60 wt %, e.g. from about 40 wt % to about 42 wt %, from about 40 wt % to about 45 wt %, from about 40 wt % to about 50 wt %, from about 50% to about 60%, from about 50 wt % to about 55 wt %, from about 55 wt % to about 57 wt %, about 40 wt %, about 45 wt %, about 50 wt % and about 60 wt %, etc. In some embodiments, the flame retardant blend comprises about 10 wt % to about 90 wt % of one or more ammonium phosphate salts. In some embodiments, the flame retardant blend comprises about 10 wt % to about 60 wt %, alternatively about 10 wt % to about 50 wt %, alternatively about 20 wt % to about 45 wt %, alternatively about 25 wt % to 45 wt %, alternatively about 30 wt % to about 50 wt %, alternatively about 35 wt % to about 45 wt %, alternatively about 37 wt % to about 43 wt %, alternatively about 40%. In some embodiments, the amount of one or more ammonium phosphate salts does not exceed about 40 wt %.

In some embodiments, the flame retardant compound(s) provides an increase in weight of the treated material (such as the fabric, fibers, or yarns) of about 1% to about 25%, alternatively about 3% to about 20%, alternatively about 5% to about 15%, alternatively about 8% to about 12%. For example, in some embodiments, the weight of the flame retardant compound(s) is about 5% to about 15% higher than the weight of the untreated material.

In addition to comprising one or more flame retardant compounds, theblend can comprise one or more additives. In some embodiments, the flame retardant blend comprises one or more bonding agents that help to the constituent fibers of the fabric network of the flame barrier cover, especially in the case of a nonwoven fabric. These bonding agents may comprise water dispersible polymers and copolymers. The most common types of bonding agents used include acrylics, nitrile elastomers, styrene butadienes, ethylene vinyl acetate copolymers and polyvinylidene chlorides, etc. Examples of suitable commercial bonding agents include Rhoplex™ (Dow Chemical Company), Eccogard™ (Eastern Color and Chemical Company) and Seyco-Rez™ (The Seydel Companies, Inc.). An emulsion is formed and added to the flame retardant blend prior to application onto the fibers, yarns or fabric of the cover, at a concentration of about 0.1 wt % to about 20 wt % (weight percentage based on total weight of the blend solution), preferably about 1 wt % to about 20 wt %, more preferably about 1 wt % to about 15 wt %, even more preferably about 1 wt % to about 10 wt % or about 1 wt % to about 5 wt %.

The flame retardant blend may also comprise one or more chemical binders that promote adherence of the flame retardant compound(s) onto the surface of the fibers, yarns or fabric. Examples of these chemical binders include but are not limited to urea, hydrogen peroxide, dimethylol dihydroxyethylethylurea (DMDHEU), dimethylol ethylene urea (DMEU), magnesium chloride, dimethylurea/glyoxal, 1,2,3,4-butanetetracarboxylic acid, sodium hydrophosphite (NaH₂PO₂), ammonia, hexabromocyclododecane, ammonium chloride, ethylene diamine, grafting 2,3-epoxypropyl methacrylate (GMA), citric acid, acrylic monomers grafting Fe²⁺/H₂O₂ redox, chitosan, and butanetetracarboxylic, etc. These chemical binders are included in the flame retardant blend formulation at a concentration of from about 0.1 wt % to about 20 wt % (weight percentage based on total weight of the blend solution), preferably about 1 wt % to about 20 wt %, more preferably about 1 wt % to about 15 wt %, even more preferably about 1 wt % to about 10 wt % or about 1 wt % to about 5 wt %. In some embodiments, the binder(s) provide an increase in weight of the treated material (such as the fabric, fibers, or yarns) of about 0.1% to about 5%, alternatively about 0.2% to about 4%, alternatively about 0.3% to about 3%, alternatively about 0.4% to about 2%, alternatively about 0.5% to about 1%. In some embodiments, the binder(s) provide an increase in weight of about 1% or less.

In one particular embodiment, the flame retardant blend contains about 30 wt % to about 75 wt % of one or more ammonium phosphate salts (i.e. monoammonium phosphate, diammonium phosphate, ammonium polyphosphate) and urea, and about 25 wt % to about 70 wt % of water; preferably about 35 wt % to about 65 wt % of one or more ammonium phosphates salts and urea, and 35 wt % to about 65% of water; more preferably about 40 wt % to about 60 wt % of one or more ammonium phosphate salts and urea, and 40 wt % to about 60% of water.

In some embodiment, the flame retardant blend comprises GTI TARD FFR-2, which is manufactured by GTI Chemical Solutions, Inc. in 10152 Greenway Hwy, Wellford, S.C. 29385. GTI TARD FFR-2 is a mixture of mono- and di-ammonium polyphosphates with less than 1% anionic surfactant. GTI TARD FFR-2 is a flame retardant blend and phosphorus based system, free of halogens and metals such as antimony, zinc and magnesium. GTI TARD FFR-2 is a clear liquid having a mild odor and 42-44% activity, having a pH of 5.5-6.4, with a weight of about 11.0 lbs per gallon.

In some embodiments, the flame retardant blend comprises GTI TARD IM, also manufactured by GTI Chemical Solutions, which comprises a blend of ammonium salts and urea. GTI TARD IM, an odorless, clear liquid, comprises a blend of inorganic salts and has a weight of about 10.45 lbs per gallon. GTI TARD IM has 40% activity, is anionic in nature, and has a pH of about 5.5 to 7.5.

In some embodiments, the flame retardant blend comprises GTI-TARD NY-22MG, which is methylol urea condensate based. GTI-TARD NY-22MG is colorless to straw-colored, is clear to slightly hazy, and has a pungent odor. GTI-TARD NY-22MG has about 42.0 to 46.0% activity, a pH of about 6.5 to 8.5, and a weight of 9.3 lbs per gallon. In some embodiments, GTI-TARD NY-22MG may be applied to ticking fabric, such as nylon ticking fabric.

The flame retardant blend may also comprise one or more of the following: surfactants, wetting agents, pH modifiers, stabilizing agents, dyes, organic solvents, sequestering or chelating agents and catalysts, etc. Surfactants are used to stabilize the polymer particles in water during emulsification. Catalysts are sometimes added to functional polymers to provide cross-linking and impart heat and chemical resistance. In some embodiments, the flame retardant blend may comprise the flame retardant compound(s), urea, and optionally water, and no additional components.

In the event that any of these terms are conflicting in whole or in part, the broadest definition is intended to be used for the purposes of this application for the present invention.

Various techniques can be employed to apply the blend to and treat the fibers, yarns or fabric of the flame barrier cover. Preferably, in order for the molecules of the flame retardant compound(s) to be physically absorbed onto without forming any chemical bond or crosslinks to the fibers, the flame retardant blend is applied using any dyeing equipment that is capable of carrying out a batch dyeing or exhaust dyeing process. Specifically, a powerful pump applies the flame retardant blend by circulating the blend through a heat exchanger outside of a main vessel. In a preferred embodiment, the flame retardant blend is applied onto the spun yarns. The variables in the processing cycles are concentration of the flame retardant compound(s) in the blend and their particle size; yarn package configuration, size and density; as well as time, temperature and amount of flow pressure through the yarn. A liquor flow during the treatment process alternates direction between inside and outside of the yarn packages. The amount of saturation of the yarns with the flame retardant blend is influenced by the presence and concentration of wetting agents and the finish on the yarns. After the treatment process, the yarns are hydroextracted, dried and then wound with wax onto a package that is suitable for knitting. Alternatively, the yarns are treated with the flame retardant blend by using a kiss roll or pad that applies the blend in a continuous process.

In another embodiment, the flame retardant blend is applied using saturation bonding by totally immersing or dipping in a bath or by flooding near the nip point of a set of pressure rolls. Excess solution is squeezed out and removed by the roll pressure. The saturation bonding method is simple and properties or parameters such as product strength, softness and concentration of each ingredient in the blend can be easily controlled.

The flame retardant blend may also be applied using spray bonding (including electrostatic spraying) where the blend is atomized by air pressure, hydraulic pressure or centrifugal forces and is applied to surfaces of the fibers, yarns of the fabric of the flame barrier cover in fine droplets using an array of spray nozzles. After spraying, the wet fiber, yarn or fabric may be passed through a hot oven to cure or crosslink and remove water by drying. In spray bonding, concentration gradients where different parts of the fiber, yarn or fabric are treated with different concentrations of the flame retardant blend can be optionally formed.

Print bonding employs engraved gravure or rotary screen-printing rolls where the pattern and thickness of the flame retardant blend coating are controlled. With this technique, it is easy to apply the blend only in predetermined areas of the fiber, yarn or fabric, if desired.

Yet alternatively, the flame retardant blend may be applied using the technique foam bonding where air and water are used as diluent and carrier for the blend. The air to the blend volume is about 5. Foam bonded fibers, yarns or fabrics consume less energy in drying as less water is used. The blend formulation may include foam-stabilizing agents to prevent the foam from collapsing during application and drying.

In some embodiments, the flame retardant blend is applied on a finishing frame with a pad squeeze roll application. In some embodiments, the process occurs in a low liquor ratio package dye machine which can be useful for exhaust dyeing many different types of fibers.

In some embodiments, the application of the blend comprising the flame retardant compound(s) provides an increase in weight of the treated material (such as the fabric, fibers, or yarns) of about 1% to about 25%, alternatively about 3% to about 20%, alternatively about 5% to about 15%, alternatively about 8% to about 12%. For example, in some embodiments, the weight of the material treated with the blend comprising the flame retardant compound(s) is about 5% to about 15% higher than the weight of the untreated material.

The flame retardant covers of the present invention can provide unexpected benefits, such that an adequate amount of flame retardant compound(s) is retained on the fibers, yarn, and/or fabric and wherein a minimal or no amount of flame retardant compound(s) is lost or come off of the fiber, yarn, and/or fiber during processing, transport, or use.

In some embodiments, the entire flame retardant cover may be comprised of the same material. In some embodiments, the flame retardant cover may be comprises of two or more materials and/or pieces. In some embodiments, the flame retardant cover may comprise one or more panels of a different or the same composition from the rest of the flame retardant cover. For example, the panel may comprise the same fiber, yarn, and/or fabric, with the same or a different type or amount of flame retardant blend applied to it, or it may comprise a different fiber, yarn, and/or fabric and the same or a different type or amount of flame retardant blend applied to it. In some embodiments, a flame retardant blend comprising GTI-TARD IM (a blend of ammonium salts and urea), manufactured by GTI Chemical Solutions, Inc., may be used. In some embodiments, the panel may comprise thermoplastic fibers or it may comprise no thermoplastic fibers. In some embodiments, the panel may comprise nonwoven material, and/or cellulosic material. In some embodiments, a panel may be additionally placed on one or more sides or surfaces of flame retardant cover. For example, a panel may be placed on the top surface of the flame retardant cover, that is the surface that will be exposed after placement of the flame retardant cover on a core of stuffing material. The one or more panels may be placed on the flame retardant cover in any manner; in some embodiments, it may be glued, sewed or merely placed on or more surfaces. In some embodiments, the use of one or more panels may reinforce the barrier and/or flame retardant effect.

In some embodiments, the flame retardant cover may be provided with a further cover that at least partially or fully covers the flame retardant cover. The further cover may comprise the same fiber, yarn, and/or fabric, with the same or a different type or amount of flame retardant blend applied to it, or it may comprise a different fiber, yarn, and/or fabric and the same or a different type or amount of flame retardant blend applied to it.

When tested in accordance with 16 C.F.R. Part 1632 mattress flammability standard, placement of 18 or more lit cigarettes on a mattress of the present invention (i.e. encased by a flame retardant cover of the present invention) results in no ignition and no char, and is therefore in full compliance with the standard.

When tested in accordance with 16 C.F.R. Part 1633 mattress flammability standard, a mattress of the present invention exhibits a maximum peak rate of heat release of no more 200 kW, and a total heat release of no more than 15 MJ at 10 minutes, and is therefore in full compliance with the standard. In one embodiment, the maximum peak rate is about 30-35 kW (e.g. 31.5 kW, 34.5 kW) and occurs at 75-90 seconds (e.g. 76 seconds, 89 seconds). In one embodiment, the total heat release at 10 minutes is no more than 15 MJ, for example, 3.5-6.5 MJ (e.g. 3.9 MJ, 6.3 MJ).

The present invention is further illustrated by the following examples which are included solely for illustrative purposes and are by no means intended to limit the scope of the appended claims.

### EXAMPLES

### Example 1

### 16 C.F.R. Part 1632 Test

Brief Description of the Test:

In accordance with paragraph 1632.4, the testroom is conditioned at greater than 18° C. (65° F.) and less than 55% relative humidity (RH) for at least 48 hours prior to testing. During the test, a minimum of 18 lit cigarettes are placed on the mattress surface. A line is drawn across the width of the mattress, dividing it into two equal sections. One of the sections was covered with a once laundered 100% cotton bed sheet. Nine lit cigarettes are placed on the covered section. A second piece of cotton sheeting is then placed over this group of nine cigarettes to intensify the heat. The other section remains uncovered. Nine lit cigarettes are placed on this uncovered section. In certain instances, cigarettes will self-extinguish. When this occurs, additional lit cigarettes must be placed on the mattress. This will increase the actual number of cigarettes beyond the minimum required total of 18. If there is an obvious ignition, that placement location is extinguished and a char length measurement is not made. In certain instances, ignition is not obvious and there may be continuous burning beyond the cigarette. When this occurs, a char length measurement is made. The mattress fails the test if any obvious ignition occurs or if there is a char measurement of more than 2″.

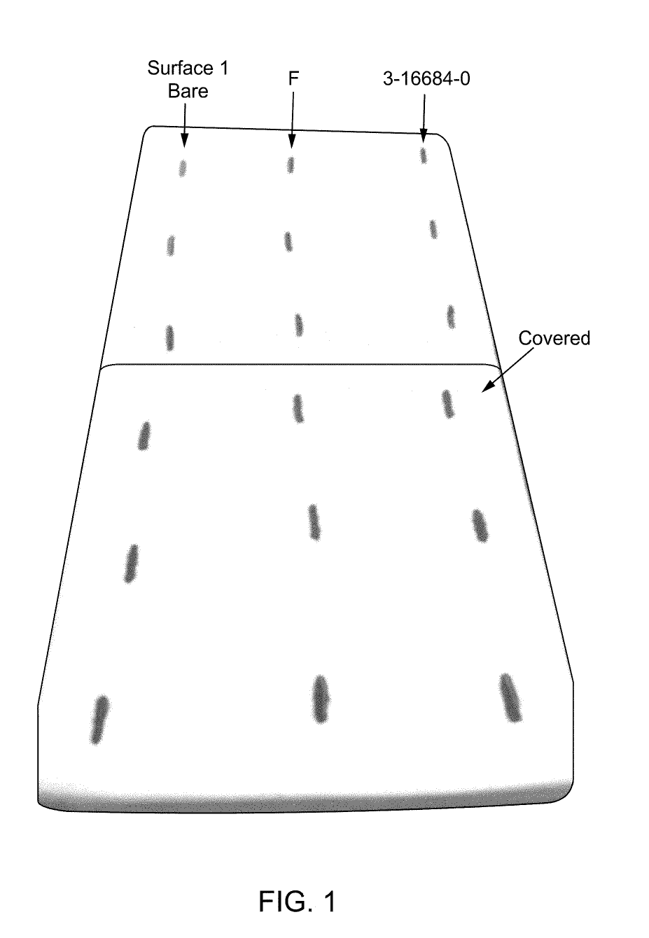

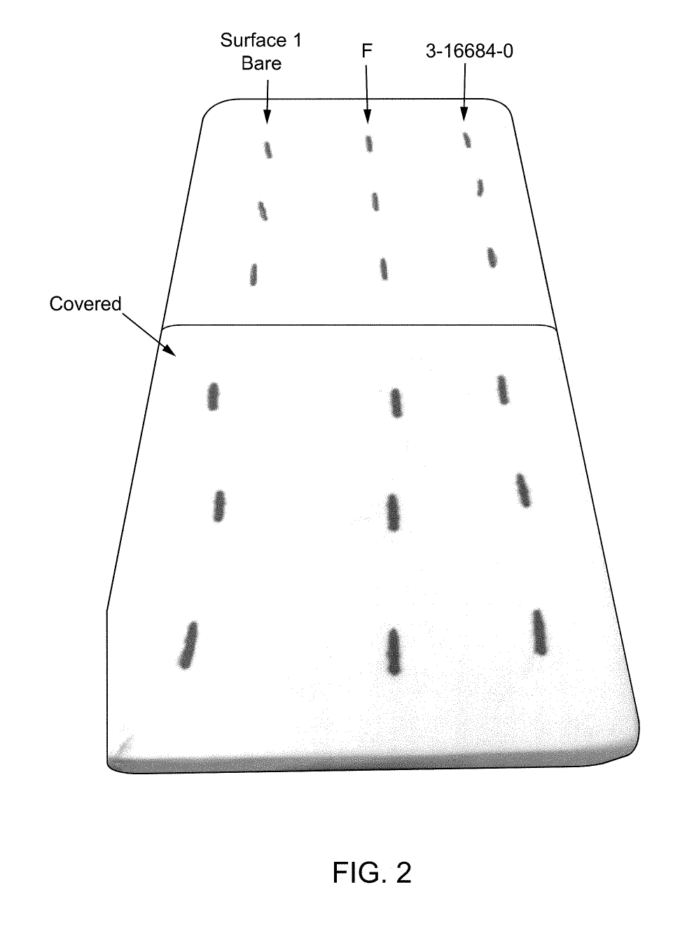

The specifications of the applicant's mattress subject to Part 1632 testing (by The Govmark Testing Services, Inc. in Farmingdale, N.Y.) are summarized in Table 1 and the results of the test are provided in FIGS. 1 and 2, and Table 2. The ignition source for the test was SRM 1196 cigarette.

TABLE 1
Specifications of tested mattress.

| | |
|---|---|
| Product identification | Twin size, prototype ID TN005 |
| Product category | Smooth surface mattress without tape edge |
| Test selection | Prototype |
| Covering material (Ticking) | Zip cover |
| Fire blocking layer (Interliner) | 80% Tencel ®, 20% polyester (ringspun) |
| Filling material | 3″ comfort layer-7′ poly support layer |

TABLE 2
Part 1632 test results (Govmark Test Report 3-16684-0).

| | | | | # of Obvious |
|---|---|---|---|---|
| | | | | Measuring |
| | Cigarette | # of | | more than 2″ |
| | Placement | Cigarette | # of Obvious | Beyond |
| | Location | Placements | Ignitions | Cigarette |
| Surface 1 | | | | |
| Bare | Edge | —* | — | — |
| (without sheets) | Smooth | 9 | 0 | 0 |
| Covered | Edge | — | — | — |
| (with sheets) | Smooth | 9 | 0 | 0 |
| Totals for Surface 1 | | 18 | 0 | 0 |
| Surface 2 | | | | |
| Bare | Edge | — | — | — |
| (without sheets) | Smooth | 9 | 0 | 0 |
| Covered | Edge | — | — | — |
| (with sheets) | Smooth | 9 | 0 | 0 |

| | | | |
|---|---|---|---|
| Totals for Surface 2 | 18 | 0 | 0 |

*(—) indicates that there was no edge to support a cigarette placement.

### Example 2

### 16 C.F.R. Part 1633 Test

Brief Description of Test:

A mattress set is placed on a support system. Flames from a multi-hole propane burner impinge on the side of the mattress set for a period of 50 seconds, and flames from a second multi-hole burner impinge on the top of the mattress set for a period of 70 seconds. The recording instrumentation in the exhaust duct evaluates the combustion product and a formula calculates the highest heat release value recorded during the test period. It also records the total heat released during the entire test. The test continues until failure occurs or 30 minutes have elapsed. Five test categories are available, namely Qualified Prototype, Confirmed Prototype, Subordinate Prototype, Production Quality Control and Experimental.

In Qualified Prototype, three mattress sets must demonstrate compliance with the acceptance criteria set forth in Part 1633 (see Table 3).

TABLE 3
Acceptance criteria of mattress set of Part 1633

| | |
|---|---|
| Peak rate of heat release | 200 kW maximum |
| Total heat releast at 10 minutes | 15 MJ maximum |

In Confirmed Prototype, one mattress set must demonstrate compliance with the acceptance criteria, and the manufacturing specifications (construction and components) of the mattress set must be the same as the manufacturing specifications for an existing Qualified Prototype mattress set.

In Subordinate Prototype, a mattress set is based on a Qualified Prototype or Confirmed Prototype. There is no requirement for a Subordinate Prototype to be tested. This test exemption is qualified by § 1633.4, which comments upon the use of different tickings; different components; different materials; different designs; or different methods of assembly. The qualification to permit these changes states that a reasonable basis should be offered to indicate that such changes would not cause the test criteria to be exceeded. Therefore, it is assumed that a test on one set of a Subordinate Prototype would support the reasonable basis theory.

In Production Quality Control, the test is an ongoing quality control test to determine if one or more actual production mattress sets conform to the Qualified Prototype.

In Experimental, the manufacturing specifications of an experimental mattress set are evaluated.

As defined in Part 1633, a “mattress set” can either be a mattress without a foundation or a mattress with a foundation. The sale of mattresses tested without foundations might be limited to that configuration.

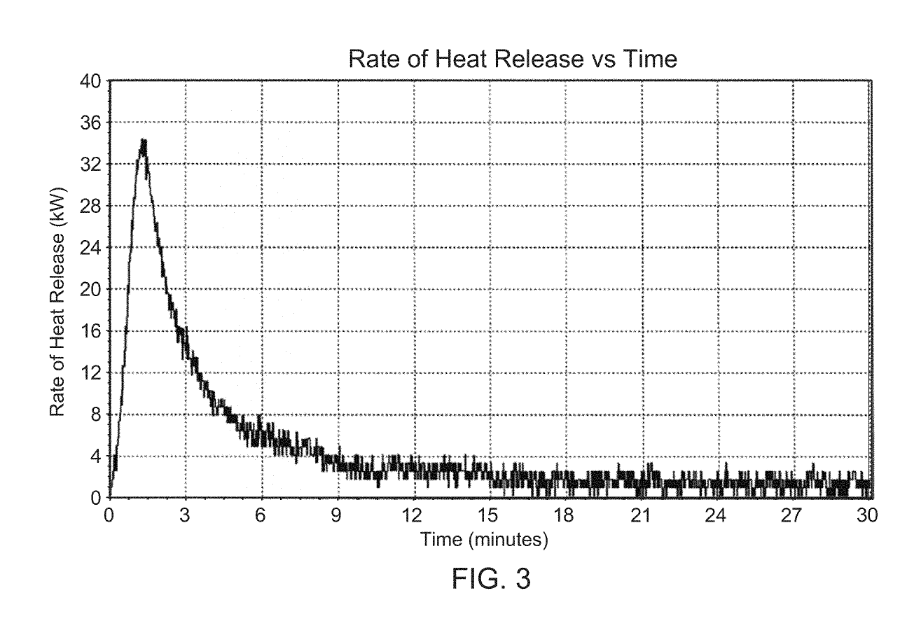

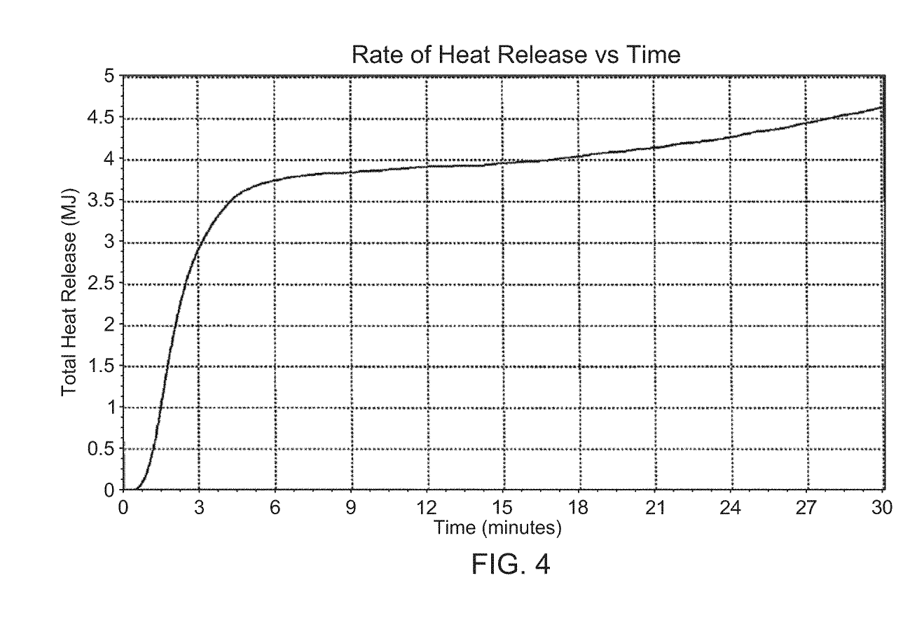

The specifications of the applicant's mattress subject to Part 1633 testing (Test category “Experimental” and by The Govmark Testing Services, Inc. in Farmingdale, N.Y.) are summarized in Table 1. The testroom configuration is given in Table 4 and the results of the test are provided in FIGS. 3 and 4, and Table 4. The testroom dimensions were 10 feet×12 feet×8 feet high. Observations during the 30-minute test in relation to flame impingement point are given in Table 5. Based on the reported results and cited acceptance criteria, the mattress set tested demonstrated compliance with the acceptance criteria.

TABLE 3
Testroom configuration for Part 1633 test

| Condition | Mattress Set 1 |
|---|---|
| Temperature (° F.) | 68 |
| (Specified: >59° F. and <80.6° F.) | |
| Humidity (% RH) | 36 |
| Specified <75% RH) | |
| Time lag between conditioning room and | 7 |
| test start (minutes) | |
| (Specified: 20 minutes maximum) | |

TABLE 4
Results for Part 1633 test (Govmark Test Report 3-16234-0)

| Categories | Mattress Set 1 |
|---|---|
| Rate of heat release: | |
| Peak (kW) | 34.5 |
| Time peak rate occurred (seconds) | 76 |
| Total heat release (MJ) at 10 minutes | 6.3 |
| (or test end, if sooner than 10 minutes) | |
| Test end: | |
| Time (mm:ss) | 30:00 |
| Code* | (2) |

Codes explained:
(1) Extinguished by technician when maximum criteria values were exceeded.
(2) Maximum test period (30 minutes).

TABLE 5
Observations recorded during Part 1633 Test

| Mattress | Time | |
|---|---|---|
| Set # | (mm:ss) | Observations |
| 1 | 00:04 | Cover material ignited. |
| | 01:20 | Burner removed; small fire traveling along top and |
| | | side cover material. |
| | 03:30 | Small fire continues to travel along cover material. |
| | 06:00 | Fire continues to slowly spread along cover |
| | | material. |
| | 09:45 | Fire diminishing along cover material; light smoke. |
| | 14:30 | Fire continues to diminish; light smoke continues. |
| | 22:00 | Small fire continues to travel on cover material. |
| | 30:00 | End of test. |

### Example 3

### 16 C.F.R. Part 1633 Test

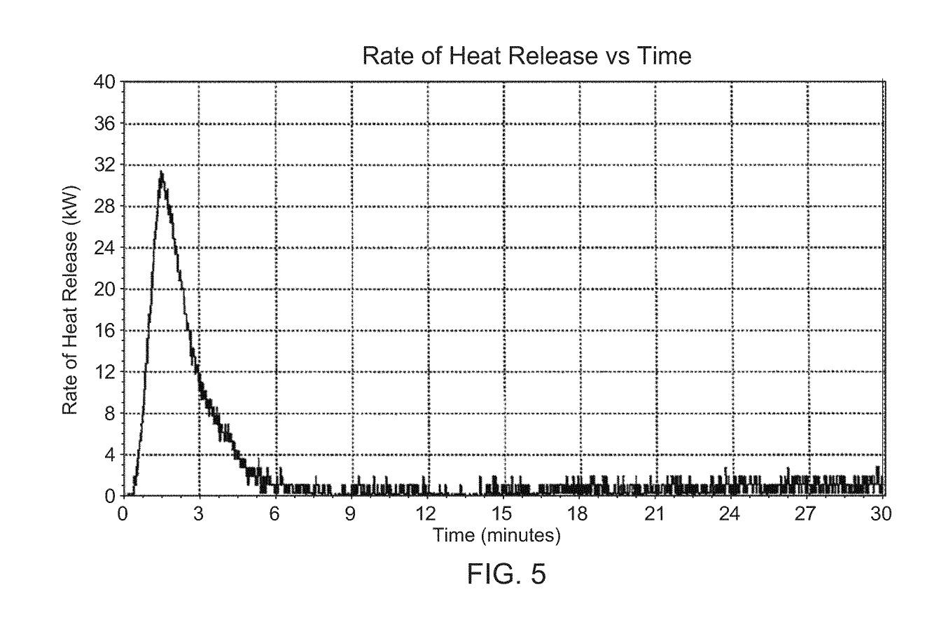

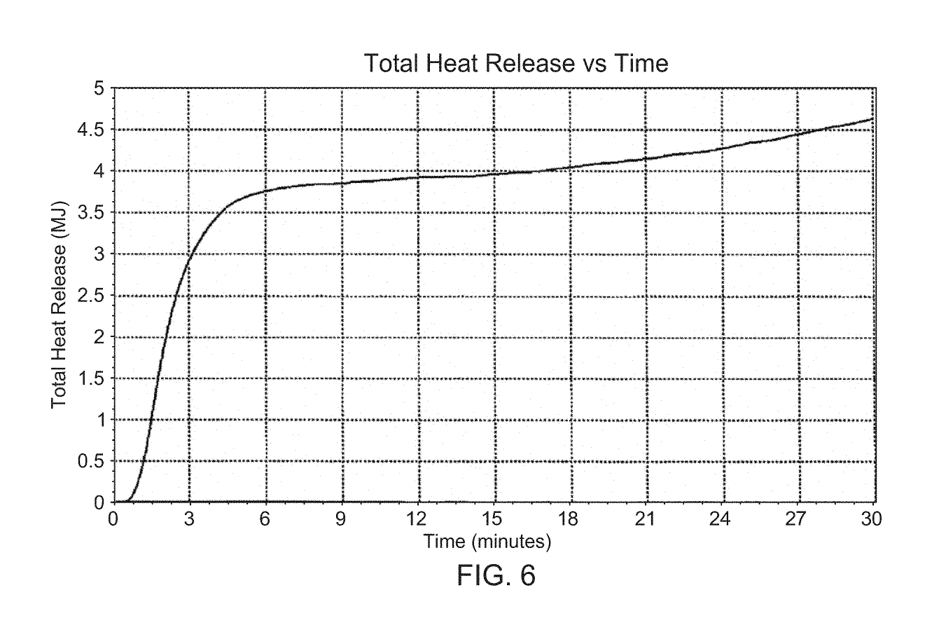

The specifications of the applicant's mattress subject to Part 1633 testing on Nov. 18, 2016 (Test category “Experimental” and by The Govmark Testing Services, Inc. in Farmingdale, N.Y.) are summarized in Table 1. The testroom configuration is given in Table 6 and the results of the test are provided in FIGS. 5 and 6, and Table 7. The testroom dimensions were 10 feet×12 feet×8 feet high. Observations during the 30-minute test in relation to flame impingement point are given in Table 8. Based on the reported results and cited acceptance criteria, the mattress set tested demonstrated compliance with the acceptance criteria.

TABLE 6
Testroom configuration for Part 1633 test

| Condition | Mattress Set 1 |
|---|---|
| Temperature (° F.) | 72 |
| (Specified: >59° F. and <80.6° F.) | |
| Humidity (% RH) | 39 |
| Specified <75% RH) | |
| Time lag between conditioning room and | 8 |
| test start (minutes) | |
| (Specified: 20 minutes maximum) | |

TABLE 8
Results for Part 1633 test (Govmark Test Report 3-16472-0)

| Categories | Mattress Set 1 |
|---|---|
| Rate of heat release: | |
| Peak (kW) | 31.5 |
| Time peak rate occurred (seconds) | 89 |
| Total heat release (MJ) at 10 minutes | 3.9 |
| (or test end, if sooner than 10 minutes) | |
| Test end: | |
| Time (mm:ss) | 30:00 |
| Code* | (2) |

Codes explained:
(1) Extinguished by technician when maximum criteria values were exceeded.
(2) Maximum test period (30 minutes).

TABLE 9
Observations recorded during Part 1633 Test

| Mattress | Time | |
|---|---|---|
| Set # | (mm:ss) | Observations |
| 1 | 00:04 | Cover material ignited. |
| | 01:10 | Burner removed; small fire remains on platform and |
| | | top of mattress. |
| | 03:00 | Small fire dripping and pooling under mattress. |
| | 05:00 | No visible fire on platform. |
| | 12:00 | No visible fire. |
| | 30:00 | End of test. |

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims. Aspects from the various embodiments described, as well as other known equivalents for each such aspect, can be mixed and matched by one of ordinary skill in the art to construct additional embodiments and techniques in accordance with principles of this application.

We claim:

1. A flame retardant cover, comprising:
a fabric comprising a network of yarns comprising a plurality of interlocked fibers; wherein
at least a portion of the fibers, yarns or fabric is treated with a blend comprising a flame retardant compound;
the fabric is substantially free of a flame barrier element; and
the flame retardant cover is adapted for at least partially enclosing a core mass of stuffing material.

2. The flame retardant cover according to claim 1, wherein the flame retardant compound is one or more selected from the group consisting of aluminum hydroxide, magnesium hydroxide, phosphoric acid, dicyandiamide, cyanoguanidine, phosphonic acid huntite, hydromagnesite, ammonium phosphate, diammonium phosphate, ammonium polyphosphate, red phosphorus, antimony trioxide, zinc borate, zinc hydroxystannate, zinc stannate, a metal hydrate, a metal oxide, ammonium bromate, diguanidine hydrogen phosphate, aluminum trihydrate, calcium carbonate, gypsum, an organohalogen compound and an organophosphorus compound.

3. The flame retardant cover according to claim 1, wherein the flame retardant compound is one or more selected from the group consisting of ammonium phosphate, diammonium phosphate and ammonium polyphosphate.

4. The flame retardant cover according to claim 1, wherein the blend comprises:
about 10 wt % to about 60 wt % of one or more flame retardant compounds,
wherein the weight percentages are based on the total weight of the blend.

5. The flame retardant cover according to claim 1, wherein the blend comprises:
about 25 wt % to about 45 wt % of one or more flame retardant compounds, wherein the weight percentages are based on the total weight of the blend.

6. The flame retardant cover according to claim 1, wherein the flame barrier element is selected from the group consisting of aramid, fiberglass, melamine, novolid, polybenzimidazole, oxidized polyarylonitrile, silica-loaded rayon and silica glass.

7. The flame retardant cover according to claim 1, wherein the flame barrier element is fiberglass.

8. The flame retardant cover according to claim 1, wherein the flame barrier element is silica-loaded rayon.

9. The flame retardant cover according to claim 1, wherein the core mass of stuffing material is contained in a manufactured article selected from the group consisting of a mattress, a mattress pad, a mattress topper, a mattress foundation, a cushion, a pillow and an upholstered furniture article.

10. The flame retardant cover according to claim 1, wherein the core mass of stuffing material is contained in a mattress.

11. A flame retardant mattress, comprising:
a core mass of stuffing material; and
a flame retardant cover adapted for at least partially enclosing the core mass of stuffing material, wherein
the flame retardant cover comprises a fabric comprising a network of yarns comprising a plurality of interlocked fibers;
at least a portion of the fibers, yarns or fabric is treated with a blend comprising a flame retardant compound; and
the fabric is substantially free of a flame barrier element.

12. The flame retardant mattress according to claim 11, wherein the flame retardant compound is one or more selected from the group consisting of aluminum hydroxide, magnesium hydroxide, phosphoric acid, dicyandiamide, cyanoguanidine, phosphonic acid huntite, hydromagnesite, ammonium phosphate, diammonium phosphate, ammonium polyphosphate, red phosphorus, antimony trioxide, zinc borate, zinc hydroxystannate, zinc stannate, a metal hydrate, a metal oxide, ammonium bromate, diguanidine hydrogen phosphate, aluminum trihydrate, calcium carbonate, gypsum, an organohalogen compound and an organophosphorus compound.

13. The flame retardant mattress according to claim 11, wherein the flame retardant compound is one or more selected ammonium phosphate, diammonium phosphate and ammonium polyphosphate.

14. The flame retardant mattress according to claim 11, wherein the blend comprises:
about 10 wt % to about 60 wt % of one or more flame retardant compounds, wherein the weight percentages are based on the total weight of the blend.

15. The flame retardant mattress according to claim 11, wherein the blend comprises:
about 25 wt % to about 45 wt % of one or more flame retardant compounds, wherein the weight percentages are based on the total weight of the blend.

16. The flame retardant mattress according to claim 11, wherein the flame barrier element is selected from the group consisting of aramid, fiberglass, melamine, novolid, polybenzimidazole, oxidized polyarylonitrile, silica-loaded rayon and silica glass.

17. The flame retardant mattress according to claim 11, wherein the flame barrier element is fiberglass.

18. The flame retardant mattress according to claim 11, wherein the flame barrier element is silica-loaded rayon.

19. The flame retardant cover according to claim 11, wherein the core mass of stuffing material is contained in a manufactured article selected from the group consisting of a mattress, a mattress pad, a mattress topper, a mattress foundation, a cushion, a pillow and an upholstered furniture article.

20. The flame retardant cover according to claim 11, wherein the core mass of stuffing material is contained in a mattress.
